(19) United States
(12) Patent Application Publication
(10) Pub. No.: US 2026/0225446 A1
(43) Pub. Date: Aug. 6, 2026

(54) AMBIENT OUTPUT SYSTEM

(71) Applicant: BENTLEY MOTORS LIMITED, Crewe (GB)

(72) Inventors: Mohamed Abd El GHANI, Crewe (GB); Thomas Robert William GRAYSON, Crewe (GB); David LEARY, Crewe (GB)

(21) Appl. No.: 19/151,201

(22) PCT Filed: Jan. 26, 2024
(86) PCT No.: PCT/GB2024/050212

§ 371 Date: Jul. 25, 2025

(30) Foreign Application Priority Data
Jan. 26, 2023 (GB) 2301102.6

(51) Int. Cl. B60K 35/28; B60K 35/10; B60K 35/21; B60K 35/22; B60K 35/26; B60Q 3/18

(52) U.S. Cl. CPC B60K 35/28; B60K 35/10; B60K 35/213; B60K 35/22; B60K 35/26; B60Q 3/18; B60K 2360/1438; B60K 2360/177; B60K 2360/178; B60K 2360/179

(57) ABSTRACT

An ambient output system for a vehicle comprising: a detector to detect a plurality of elements of an environment external to the vehicle; an identification unit to identify each element; a rendering unit to create a virtual space representing the external environment, the rendering unit operable to populate the virtual space with the vehicle and each identified element; an association unit operable to apply a respective emanating field to each identified element within the virtual space, each emanating field being based on, and emanating from, the identified element to an associated range; one or more ambient output devices operable to set the internal ambient environment of the vehicle; and an orchestration unit operable to determine any emanating fields the vehicle is within in the virtual space and set the output of the ambient output devices based on any emanating fields the vehicle is within.

### TECHNICAL FIELD OF THE INVENTION

The present invention relates to an output system for a vehicle, in particular but not exclusively to an output system for an automotive vehicle.

BACKGROUND TO THE INVENTION

In the vehicle industry, particularly the automotive vehicle industry, there has been an increase in ambient output devices (e.g. lighting, audio systems, screens) within vehicles. The different ambient output devices improve the ambience of the environment of the vehicle (for example, LED strips and dashboard lighting forming lighting trim), but can also convey information to a user of the vehicle on the external environment. Control of the ambient environment can thereby provide a more immersive environment for multiple vehicle occupants simultaneously.

For example, DE102018207848A1 discloses an ambient output system that comprises sensors to detect the external environment and a control unit which controls output devices based on the detected external environment. In one example, a video camera records images of the external environment and the most striking colours of the vehicle's surroundings are extracted and used to control ambient lighting inside the vehicle.

There is a variety of information it is useful to convey to the user, and it is useful to be able to convey different information at the same time. This results in a lot of computer control systems being operational at the same time, resulting in an energy drain. This is particularly problematic for electric vehicles. It can also be distracting and confusing for a driver.

Further to the above, each ambient output requiring its own control set up results in the control system for vehicles becoming more and more complex. This further increases the energy drain, and also makes the control system more likely to fail and more difficult to fix.

Embodiments of the present invention seek to overcome/ameliorate these or other disadvantages.

### SUMMARY OF THE INVENTION

According to a first aspect of the present invention there is provided an ambient output system for a vehicle comprising:
a) a detector operable to detect a plurality of elements of an environment external to the vehicle;
b) an identification unit operable to identify each element;
c) a rendering unit operable to create a virtual space representing the environment external to the vehicle, the rendering unit operable to populate the virtual space with the vehicle and each identified element;
d) an association unit operable to apply a respective emanating field to each identified element within the virtual space, the respective emanating field being based on the identity, and each emanating field emanating from the identified element, and within the virtual space, to an associated range;
e) one or more ambient output devices operable to set the internal ambient environment of the vehicle; and
f) an orchestration unit operable to determine any emanating fields the vehicle is within in the virtual space and set the output of the one or more ambient output devices at least partially based on any emanating field or emanating fields the vehicle is within.

Thus, the range and position of each emanating field is dependent both on the position and identity of each element in the external environment. This helps ensure the ambient output system can better account for various factors associated with external elements as described further below.

Additionally, by rendering a virtual space, populating that space with the identified elements, associating emanating fields with these elements and setting the outputs of ambient output devices based on the emanating fields the vehicle is within, one system can keep track of multiple elements within an external environment and determine which of these elements to convey via the ambient output devices. Accordingly, there is less of an energy drain on the vehicle and the control systems of the vehicle are less complex, for example the control systems do not need to measure distances between lots of different objects and can instead simply identify if the vehicle is inside or outside of given emanating field.

The identification unit may assign an identity to each element. The detector may be operable to detect a one or more inputs representing the plurality of elements. The identification unit may be operable to identify each element based on the one or more inputs. The ambient output system may comprise a plurality of detectors.

Each emanating field may have an associated set of conditions. The set of conditions may dictate the output for the one or more ambient output devices. One or more of the emanating fields may have an associated priority rating. One or more of the emanating fields may have the associated set of conditions and one or more priority ratings, each priority rating associated with a respective one or more of the set of conditions.

The vehicle in the virtual space may comprise an associated vehicle emanating field. The orchestration unit may be operable to determine any emanating fields the vehicle is within by determining any emanating fields of identified elements which overlap with the vehicle emanating field. The vehicle emanating field may emanate from the centre of the vehicle. The vehicle emanating field may emanate from an outside edge of the vehicle. The vehicle emanating field preferably extends outside the outside edge of the vehicle. The vehicle emanating field may be circular, or it may be non-circular. The vehicle emanating field may be an oval. The vehicle emanating field may correspond to the shape of the vehicle. The vehicle emanating field may comprise a major axis. The vehicle emanating field may be longest when measured along its major axis. The major axis may be aligned with a heading of the vehicle. The heading of the vehicle may correspond to the direction the vehicle is pointing in, e.g. it may be parallel to its length, and/or it may correspond to a predicted direction of movement of the vehicle, e.g. it may depend on a steering angle applied when the vehicle is an automobile. Thus, the output system is able to better account for the vehicle's own position and heading.

The ambient output system may comprise a memory unit. The memory unit may be operable to store a list of priority ratings associated with identities. The memory unit may be operable to store a list of sets of conditions associated with identities. The memory unit may be operable to store a list of ranges of emanating fields associated with identities. The memory unit may be operable to store a list of shapes of emanating fields associated with identities. The ‘identities’ of course each preferably corresponding to a respective external element. The size of the or each range may be proportional to the relevance of the respective identity to a user of the vehicle. The size of the or each range may be proportional to the impact the respective identity will have to the user of the vehicle.

The association unit may be operable to look-up in the memory unit the range and/or shape of an emanating field associated with the identity of the or each element and thereby set the emanating field for each element. The association unit may be operable to set the same shape for every emanating field. The association unit may be operable to look-up in the memory unit the set of conditions and/or priority rating associated with the identity of each element and associate each set of conditions and/or priority rating with the respective emanating field.

The orchestration unit may be operable to use the set of conditions associated with the emanating field in which the vehicle is within the range as the set of conditions for the one or more ambient output devices. Thus, the orchestration unit may be operable to use a set of conditions associated with an emanating field in which the vehicle is within to set the output of the one or more ambient output devices. The orchestration unit may be operable to determine a set of conditions for the one or more ambient output devices based on a combination of a plurality of sets of conditions. The orchestration unit may be operable to determine a set of conditions for the one or more ambient output devices based on a combination of a plurality of sets of conditions, each set of conditions associated with a respective emanating field in which the vehicle is within range. Thus, the orchestration unit may be operable to set the output of the one or more ambient output devices based on a combination of a plurality of sets of conditions, each set of conditions being associated with a respective emanating field which the vehicle is within. The orchestration unit may be operable to determine a set of conditions for the one or more ambient output devices based on a combination of a plurality of sets of conditions, one set of conditions being a default set of conditions and the rest of the plurality of sets of conditions each being associated with a respective emanating field in which the vehicle is within range. Thus, the orchestration unit may be operable to set the output of the one or more ambient output devices based on a combination of a plurality of sets of conditions, one set of conditions being a default set of conditions and the rest of the plurality of sets of conditions each being associated with a respective emanating field which the vehicle is within. The default set of conditions may have the lowest priority rating associated with it. The orchestration unit may be operable to compare the conditions of the plurality of sets of conditions and:
i) when one or more conditions for a particular output conflict with one or more of the other conditions for the particular ambient output device, the orchestration unit is operable to select the conflicting one or more conditions with the highest priority rating to put into effect and disregard the conflicting one or more other conditions; and
ii) when one or more conditions for a particular output do not conflict with one or more other conditions for the particular ambient output device, the orchestration unit is operable to put the non-conflicting one or more conditions into effect.

Thus, the orchestration unit may be operable to compare the conditions of the plurality of sets of conditions and:
a. when two or more conditions for a particular output setting of the one or more ambient output devices conflict, the orchestration unit may be operable to select the conflicting one or more conditions with the highest priority rating to put into effect and disregard the conflicting one or more other conditions; and
b. when two or more conditions for a particular output setting of the one or more ambient output devices do not conflict, the orchestration unit may be operable to put the non-conflicting two or more conditions into effect.

The one or more ambient output devices may comprise any of the following: ambient lighting devices such as LED lights or sections of LED strips, speakers, vibrating car seats, an electronic screen, dash board lights, and/or olfactory actuators. Some or all of the ambient lighting devices/LED lights may form an LED ceiling panel. Some or all of the ambient lighting devices/LED lights may form a waterfall light. The electronic screen may be a touch screen. The electronic screen may be a dynamic music visualiser. Thus, the system can ensure the ambient environment of the vehicle is controlled effectively for all vehicle occupants.

The ambient output system may comprise two or more ambient output devices. Each of the two or more ambient output devices may be associated with a different location in the vehicle. For example, an ambient output device may be associated with a front, rear, left, right, top, or bottom of the vehicle, or combinations thereof. Preferably, the two or more ambient output devices comprise at least: left and right output devices; and/or front and rear output devices. The left and right output devices may be configured for placement on the left and right sides of a vehicle, for example. Similarly, the front and rear output devices may be configured for placement at the front/rear of the vehicle. Preferably, the two or more ambient output devices comprise ambient light devices and speakers. Thus, the ambient output devices may be placed (and installed) at different locations around the vehicle to ensure the internal ambient environment is effectively controlled and can account for variations in the environment outside the vehicle.

The conditions may include any of the following: the brightness of one or more of the ambient output devices and/or part of the electronic screen, the volume of one or more of the ambient output devices, the status of one or more of the ambient output devices as on or off, a pattern formed across a plurality of ambient output devices and/or electronic screen, the status of one or more of the ambient output devices and/or part of the electronic screen as flashing, and/or the frequency of the flashing of the one or more ambient output devices and/or part of the electronic screen.

The orchestration unit may be operable to determine the position of each element for which the vehicle is within the emanating field relative to the vehicle. Thus, for one or more elements corresponding to emanating fields the vehicle is within in the virtual space, the orchestration unit may be operable to determine the position of the one or more elements relative to the vehicle. The orchestration unit may be operable to adjust the set of conditions corresponding to an element based on the position of the respective element relative to the vehicle. The orchestration unit may be operable to adjust the set of conditions to be applied to the ambient output device, ambient output devices, or part of ambient output device based on the position of the respective element relative to the vehicle. The position, relative to a centre of the vehicle, of the ambient output device, ambient output devices, or part of ambient output device to which a set of conditions is to be applied may mirror the position of the respective element relative to the vehicle. The set of conditions of the one or more elements may contain an indication for the orchestration unit to determine the position.

The detector or one or more of the detectors may be in-built detectors. The detector or one or more of the detectors may be a sensor. The detector or one or more of the detectors may be a camera. The detector or one or more of the detectors may be a microphone. The detector or one or more of the detectors may be a GPS locator. The detector or one or more of the detectors may be a clock. The detector or one or more of the detectors may be a temperature sensor. The detector or one or more of the detectors may be a receiver. One or more of the receivers may be operable to receive an input from an external device. The detector or one or more of the detectors may be an orientation sensor. The detector or one or more of the detectors may be an altitude sensor. The detector or one or more of the detectors may be a pressure sensor. The or each pressure sensor may be operable to detect the presence of a person in one or more of the seats of the vehicle. The detector or one or more of the detectors may be an anemometer. The detector or one or more of the detectors may be an olfactory sensor.

The identification unit may be operable to label each element to identify it. The memory unit may be operable to store priority ratings, set of conditions, ranges, and/or shapes for each label. The identification unit may be operable to apply a plurality of labels to one or more of the elements to identify it. The or each plurality of labels may be a respective main label and respective one or more descriptive labels, the main label naming the element and each of the one or more descriptive labels describing the element. The orchestration unit may be operable to determine each set of condition, range, priority rating, and/or shape for each element by combining the sets of conditions, ranges, priority ratings, and/or shapes of the main label and one or more descriptive labels. When combining the sets of conditions, ranges, priority ratings and/or shapes of the main label and one or more descriptive labels, when conditions, the range, the priority rating, and/or the shape of the main label conflicts with conditions, the range, the priority rating, and/or the shape of one of more of the descriptive labels, the orchestration unit may be operable to overwrite for the element the conflicting conditions, range, priority rating, and/or shape of the main label with the conflicting conditions, ranges, priority ratings, and/or shapes of the one or more descriptive labels. When conditions, ranges, priority ratings, and/or shapes of a plurality of descriptive labels conflict, the orchestration unit may be operable to overwrite for the element conflicting conditions, range, priority rating, and/or shape with the conflicting conditions, range, priority rating, and/or shape of the descriptive label with the highest priority rating. Each label may be any of the following: name of element, colour of element, general position of element relative to vehicle, type of weather element, intensity of weather element, general temperature, general time of day, country, general elevation of vehicle, action of element, connection status of vehicle to external devices, genre of music, song name, type of vehicle mode, occupancy of seats of the vehicle, and/or general charged status of battery of the vehicle.

Thus, the identification unit may be operable to determine a time of day. The orchestration unit may be operable to set the output of the one or more output devices at least partially based on the time of day. This allows the system to take account of the time of day as well as external elements when controlling the output devices.

The or each detector may be operable to detect a plurality of parameters relating to an element. The memory unit may be operable to store a set of parameters and/or parameter ranges associated with each identity. The identification unit may be operable to compare the one or more parameters of each element with the set of parameters and/or parameter ranges to determine the identity of the element. The identification unit may be operable to determine the identity of the element based on to which set of parameters and/or parameter ranges its one or more parameters are closest. The association unit may be operable to use one or more of the parameters of each element as part of the set of conditions for the respective element. The association unit may be operable to use the parameter or parameters of each element as the set of conditions for the respective feature. The association unit may be operable to use the parameter or parameters of each feature as the set of conditions for the respective feature dependent upon the identity of the feature. The association unit may be operable to determine each set of conditions based or partly based on parameter or parameters of each feature. In such embodiments, the association unit may be operable to bypass looking up a set of conditions and/or priority rating based on the identity of the feature. The association unit may be operable to bypass looking up a set of conditions and/or priority rating based on the importance of the identity of the feature.

The identification unit and memory unit may form an Artificial Intelligence labelling system to identify each element. The Artificial Intelligence labelling system may be operable to train to determine the set of parameters and/or parameter ranges associated with each identity.

Each parameter may be any of the following: brightness value, speed value, GPS coordinates, altitude, time, colour, sound intensity, frequency of flashing, frequency of audio, reflectivity, position relative to the vehicle, motion, position of object or element relative to vehicle, pattern.

The detector or one or more of the detectors may be operable to obtain an input of the plurality of elements. The input may be an image or series of images. The input may be audio signal. The identification unit may be operable to carry out image recognition to determine the identity of each element within the image or series of images. The identification unit may be operable to carry out signal separation to separate the elements from the rest of an input. The identification unit may be operable to carry out object localisation to determine the location of one or more elements within an image or series of images. The identification unit may be operable to carry out audio signal separation to separate an audio sample specific to each element from the rest of an audio signal. The identification unit may be operable to carry out signal identification on the audio sample to identify the element. The identification unit may be operable to carry out object recognition to identify elements localised by object localisation. The identification unit may be operable to carry out audio signal identification to identify the or each separated audio sample. The identification unit may be operable to determine a parameter which is the position of the or each element relative to the vehicle based on the object localisation.

The orchestration unit may be operable to determine a plurality of priority ratings for one or more of the elements, each priority rating of each feature being associated with a respective subset of conditions of the set of conditions. The orchestration unit may be operable to compare the conditions of the subsets of conditions.

The memory unit may be operable to store the plurality of priority ratings for the one or more identifiable elements.

The ambient output system may comprise a selection unit operable by a user to input one or more selections, the or each selection setting a default set of conditions for the or each ambient output device. The or each selection may have an associated priority rating. The orchestration unit may be operable to determine the conditions for the unit or units of the ambient output based on a combination of the sets of conditions for the elements and the default set of conditions. The selection unit may comprise a touchscreen. The selection unit may comprise the same touchscreen as the ambient output device.

The vehicle may be an automotive vehicle, or automobile. The automotive vehicle may be a car.

The selection unit may be arranged to allow a user to select which detector or detectors to use, the other detectors being disregarded by the identification unit. The identification unit may be operable to request an input from one or more of the detectors. The request may be in response to a selection by the user. The selection unit may be arranged to allow a user to select one or more identities. The identification unit may be operable to disregard elements whose identities do not match the or one of the selected identities.

One or more of the set of conditions may be set in a factory setting. The or each set of conditions may be set in a factory setting. One or more of the set of conditions may be set by a user. The selection unit may be operable to allow a user to set one or more of the set of conditions.

The identification unit may be operable to request one or more inputs from one or more detectors. The identification unit may be operable to request one or more inputs from one or more detectors upon receipt of a different input. The identification unit may be operable to request one or more inputs from one or more detectors upon identification of a different input, dependent upon the particular type of input. The identification unit may be operable to request one or more inputs from one or more detectors upon identification of a different input, dependent upon the specific parameters making up the different input.

The identification unit may be operable to repeatedly request one or more inputs from one or more detectors. The repeat may be on a set period. The set period may be 60 times every second.

The orchestration unit may be operable to convey an indication of each element via the set of conditions acting upon the one or more ambient output devices. The orchestration unit may be operable to limit the number of identified elements to be conveyed, the elements not conveyed being disregarded. The identified elements to be conveyed may be those with the highest priority ratings. The identified elements to be conveyed may be those selected by the user. The selection unit may be operable to allow a user to select the identified elements to be conveyed. The selection unit may be operable to allow a user to set the priority ratings associated with identified elements.

The identification unit may be operable to identify if an external element is an emergency services vehicle (EMS vehicle). The identification unit may be operable to label an element as an EMS vehicle. The priority rating of an EMS vehicle may be higher than the priority rating of other elements. The orchestration unit may be operable to detect if one or more elements are labelled as EMS vehicle. If one or more elements are labelled as EMS vehicle, the orchestration unit may set the output of the one or more ambient output devices based only on sets of conditions associated with elements labelled as EMS vehicle. The orchestration unit may therefore disregard elements that are not labelled as an EMS vehicle. This ensures that the ambient output devices can quickly and accurately ensure the vehicle occupants are aware of the presence of an EMS vehicle.

The detector may be operable to detect one or more other elements of the environment external to the vehicle. The identification unit may be operable to identify the or each other element of the environment. The rendering unit may be operable to populate the virtual space with the or each identified other element. The virtual space may be a 3D virtual space. The 3D virtual space may be a vector space.

The or each emanating field may be an aura. The or each emanating field may emanate from a centre of the element. The or each emanating field may emanate from an outside edge of the element. The or each emanating field preferably extends outside the outside edge of the element. One or more of the emanating fields may be an oval. One or more of the emanating fields may be a circle. One or more of the emanating fields may be non-circular. One or more of the emanating fields may correspond to the shape of the element. One or more of the emanating fields may comprise a major axis. One or more of the emanating fields may be longest when measured along its major axis. The major axis may be aligned with a heading of the element. The heading of the element may correspond to the direction the element is pointing in, and/or it may correspond to a predicted direction of movement of the element, e.g. it may depend on a steering angle applied when the element is an automobile. Thus, the output system is able to better account for each element's position and heading.

In a preferred embodiment, the vehicle emanating field is aligned with a heading of the vehicle and one or more of the emanating fields comprise a major axis aligned with a heading of a respective element. Thus, the output system can better account for both the heading of the vehicle and each element simultaneously.

Where an emanating field is non-circular, it may have a minor axis. The minor axis may be at least half its major axis, preferably the minor axis is about half the major axis. The minor axis may be arranged perpendicular to its major axis. Thus, the emanating field extends less in directions which are less relevant to the movement of the element/vehicle.

Where an element is determined as an emergency service vehicle (EMS vehicle), the corresponding emanating field may be larger than for other elements. The emanating field may be at least double the size of an emanating field corresponding to other elements, such as ordinary vehicles. Thus, the ambient output system can ensure emergency vehicles are accounted for earlier.

A non-circular emanating field may be assigned to an element that is deemed fast moving. For example, it may have a movement speed of at least walking pace if it is fast moving. This allows the system to ensure upcoming changes in position of fast moving objects are better accounted for.

The or each detector may be operable to detect changes in each element. The rendering unit may be operable to update the virtual space to reflect detected changes. The or each detector may be operable to detect a change in position of each element relative the vehicle. The rendering unit may be operable to update the position of each element relative the vehicle in the virtual space to reflect the change.

The ambient output system may comprise one or more internal detectors operable to detect one or more elements of the internal environment of the vehicle. The identification unit may be operable to identify these internal elements. The association unit may be operable to look up a set of conditions and/or priority ratings for the internal elements. The orchestration unit may be operable to set the output of the ambient output devices at least partially on the set of conditions of the internal elements.

One or more of the internal detectors may be receivers. The receivers may be operable to receive an indication of the status of the vehicle. The status of the vehicle may be any or all of the following: traction control setting, ride height, mode setting, steering angle, HVAC setting, accelerometer data, wake up, selection of a function by a user, output of the radio, connection to an external device, a particular door of the vehicle being open, and/or charging status.

According to a second aspect of the present invention there is provided a vehicle comprising the ambient output system of the first aspect.

By rendering a virtual space, populating that space with the identified elements, associating emanating fields with these elements and setting the outputs of ambient output devices based on the emanating fields the vehicle is within, one system can keep track of multiple elements within an external environment and determine which of these elements to convey via the ambient output devices. Accordingly, there is less of an energy drain on the vehicle and the control systems of the vehicle are less complex.

The or each ambient output device may form part of an internal environment of the vehicle. The or each ambient output device may be positioned to, during use, set the ambience of the internal environment. The ambient output system may comprise two or more ambient output devices. The two or more ambient output devices may be provided spaced around the vehicle. Of course, where two ambient output devices are spaced around the vehicle, further output devices may be placed between them and thus a continuous array of ambient devices may extend around at least part of the vehicle. In one example, an ambient output device may be a LED strip light. In this example, the different ends or sections of the strip may be different ambient output devices within the meaning of the invention and spaced from one another. Thus, the ambient output devices can better control the internal ambient environment of the vehicle.

One or more of the detectors may be positioned exposed to the external environment of the vehicle, to detect the plurality of elements of the external environment. The one or more of the detectors may be positioned on the body of the vehicle.

The second aspect of the present invention may comprise any one or more, or all, of the features of first aspect, optional or otherwise, as desired or required.

According to a third aspect of the present invention there is provided a method of providing an ambient environment for a vehicle, comprising:
a) detecting a plurality of elements of an environment external to the vehicle;
b) identifying each element;
c) rendering a virtual space representing the environment external to the vehicle and populating the virtual space with the vehicle and each identified element;
d) applying a respective emanating field to the or each identified element within the virtual space, the respective emanating field being based on the identity, and each emanating field extending from the identified element, and within the virtual space, to an associated range;
e) determining any emanating fields the vehicle is within in the virtual space and setting the output of one or more ambient output devices of the vehicle at least partially based on any emanating field or emanating fields the vehicle is within.

By rendering a virtual space, populating that space with the identified elements, associating emanating fields with these elements and setting the outputs of ambient output devices based on the emanating fields the vehicle is within, one system can keep track of multiple elements within an external environment and determine which of these elements to convey via the ambient output devices. Accordingly, there is less of an energy drain on the vehicle and the control systems of the vehicle are less complex.

The method may comprise detecting one or more inputs representing the plurality of elements. The method may comprise identifying each element based on the one or more inputs.

The method may comprise the step of storing a list of priority ratings associated with identities. The method may comprise the step of storing a list of sets of conditions associated with identities. The method may comprise the step of storing a list of ranges of emanating fields associated with identities. The method may comprise the step of storing a list of shapes of emanating fields associated with identities.

Orchestrating may comprise determining any emanating fields the vehicle is within by determining any emanating fields of identified elements which overlap with the emanating field of the vehicle.

Associating may comprise looking up the range and/or shape of an emanating field associated with the identity of the or each element and thereby set the emanating field for each element. Associating may comprise setting the same shape for every emanating field. Associating may comprise looking up the set of conditions and/or priority rating associated with the identity of each element and associate each set of conditions and/or priority rating with the respective emanating field.

Orchestrating may comprise using the set of conditions associated with the emanating field in which the vehicle is within the range as the set of conditions for the one or more ambient output devices. Orchestrating may comprise determining a set of conditions for the one or more ambient output devices based on a combination of a plurality of sets of conditions. Orchestrating may comprise determining a set of conditions for the one or more ambient output devices based on a combination of a plurality of sets of conditions, each set of conditions associated with a respective emanating field in which the vehicle is within range. Orchestrating may comprise determining a set of conditions for the one or more ambient output devices based on a combination of a plurality of sets of conditions, one set of conditions being a default set of conditions and the rest of the plurality of sets of conditions each being associated with a respective emanating field in which the vehicle is within range. Orchestrating may comprise comparing the conditions of the plurality of sets of conditions and:
iii) when one or more conditions for a particular output conflict with one or more of the other conditions for the particular ambient output device, selecting the conflicting one or more conditions with the highest priority rating to put into effect and disregard the conflicting one or more other conditions; and
iv) when one or more conditions for a particular output do not conflict with one or more other conditions for the particular ambient output device, putting the non-conflicting one or more conditions into effect.

Orchestrating may comprise determining the position of each element for which the vehicle is within the emanating field relative to the vehicle. Orchestrating may comprise adjusting the set of conditions based on the position of the respective element relative to the vehicle. Orchestrating may comprise adjusting the set of conditions to be applied to the ambient output device, ambient output devices, or part of ambient output device based on the position of the respective element relative to the vehicle.

Identifying may comprise labelling each element to identify it. The method may comprise storing priority ratings and/or set of conditions for each label. Identifying may comprise applying a plurality of labels to one or more of the elements to identify it. Orchestrating may comprise determining each set of condition and priority rating for each element by combining the sets of conditions and priority rating of the main label and one or more descriptive labels. When combining the sets of conditions and priority rating of the main label and one or more descriptive labels when conditions and/or the priority rating of the main label conflicts with conditions or the priority rating of one of more of the descriptive labels, orchestrating may comprise overwriting the conflicting conditions and/or priority rating of the main label with the conflicting conditions and/or priority ratings of the one or more descriptive labels. When conditions and/or priority ratings of a plurality of descriptive labels conflict, orchestrating may comprise overwriting conflicting conditions and/or priority ratings with the conflicting conditions and/or priority rating of the descriptive label with the highest priority rating.

The method may comprise detecting a plurality of parameters relating to an element. The method may comprise storing a set of parameters and/or parameter ranges associated with each identity. Identifying may comprise comparing the one or more parameters of each element with the set of parameters and/or parameter ranges to determine the identity of the element. Identifying may comprise determining the identity of the element based on to which set of parameters and/or parameter ranges its one or more parameters are closest. Associating may comprise using one or more of the parameters of each element as part of the set of conditions for the respective element. Associating may comprise using the parameter or parameters of each element as the set of conditions for the respective feature. Associating may comprise using the parameter or parameters of each feature as the set of conditions for the respective feature dependent upon the identity of the feature. Associating may comprise determining each set of conditions based or partly based on parameter or parameters of each feature. In such embodiments, associating may comprise bypassing looking up a set of conditions and/or priority rating based on the identity of the feature. Associating may comprise bypassing looking up a set of conditions and/or priority rating based on the importance of the identity of the feature.

Detecting may comprise obtaining an input of the plurality of elements. Identifying may comprise carrying out image recognition to determine the identity of each element within the image or series of images. Identifying may comprise carrying out signal separation to separate the elements from the rest of an input. Identifying may comprise carrying out object localisation to determine the location of one or more elements within an image or series of images. Identifying may comprise carrying out audio signal separation to separate an audio sample specific to each element from the rest of an audio signal. Identifying may comprise carrying out signal identification on the audio sample to identify the element. Identifying may comprise carrying out object recognition to identify elements localised by object localisation. Identifying may comprise carrying out audio signal identification to identify the or each separated audio sample. Identifying may comprise determining a parameter which is the position of the or each element relative to the vehicle based on the object localisation.

Orchestrating may comprise determining a plurality of priority ratings for one or more of the elements, each priority rating of each feature being associated with a respective subset of conditions of the set of conditions. Orchestrating may comprise comparing the conditions of the subsets of conditions.

The method may comprise storing the plurality of priority ratings for the one or more identifiable elements.

The method may comprise detecting one or more other elements of the environment external to the vehicle. The method may comprise identifying the or each other element of the environment. The method may comprise populating the virtual space with the or each identified other element.

The method may comprise inputting, by the user, one or more selections, the or each selection setting a default set of conditions for the or each ambient output device. Orchestrating may comprise determining the conditions for the unit or units of the ambient output based on a combination of the sets of conditions for the elements and the default set of conditions.

The method may comprise selecting which inputs to use, the other inputs being disregarded when identifying. Identifying may comprise requesting one or more particular inputs. The method may comprise the user selecting one or more identities. identifying may comprise disregarding elements whose identities do not match the or one of the selected identities.

The method may comprise a user setting one or more of the set of conditions.

Identifying may comprise requesting one or more inputs from one or more detectors. Identifying may comprise requesting one or more inputs from one or more detectors upon receipt of a different input. Identifying may comprise requesting one or more inputs from one or more detectors upon identification of a different input, dependent upon the particular type of input. Identifying may comprise requesting one or more inputs from one or more detectors upon identification of a different input, dependent upon the specific parameters making up the different input.

Identifying may comprise repeatedly requesting one or more particular inputs.

Orchestrating may comprise conveying an indication of each element via the set of conditions acting upon the one or more ambient output devices. Orchestrating may comprise limiting the number of identified elements to be conveyed, the elements not conveyed being disregarded. The method may comprise the user selecting identified elements to be conveyed. The method may comprise the user setting the priority ratings associated with identified elements.

The method may comprise detecting one or more other elements of the environment external to the vehicle. The method may comprise identifying the or each other element of the environment. The method may comprise populating the virtual space with the or each identified other element.

The method may comprise detecting changes in each element. The method may comprise updating the virtual space to reflect detected changes. The method may comprise detecting a change in position of each element relative to the vehicle. The method may comprise updating the position of each element relative the vehicle in virtual space to reflect the change.

The third aspect of the present invention may comprise any one or more, or all, of the features of first and second aspects, optional or otherwise, as desired or required.

### DETAILED DESCRIPTION OF THE INVENTION

In order that the invention may be more clearly understood one or more embodiments thereof will now be described, by way of example only, with reference to the accompanying drawings, of which:

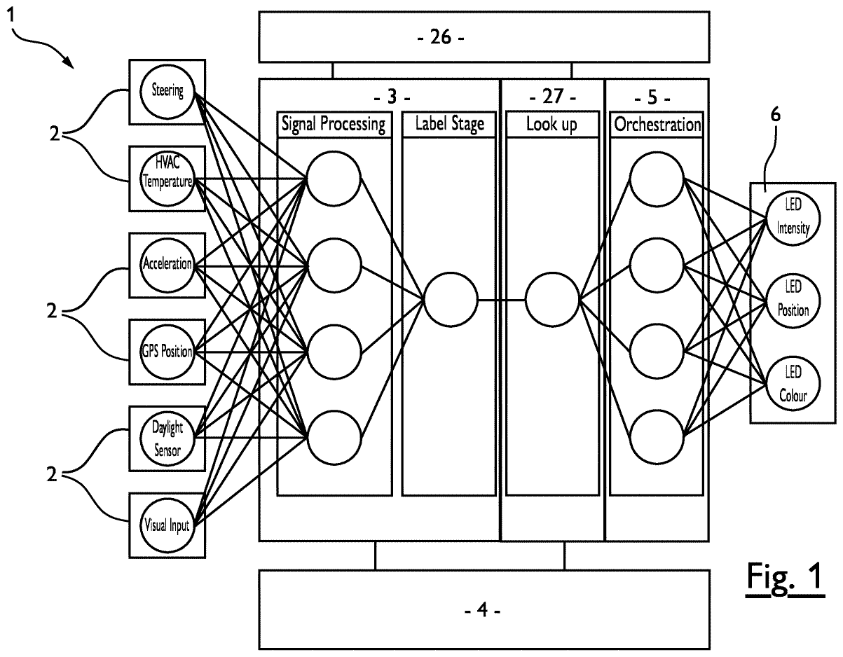

FIG. 1 is a block diagram of an ambient output system;

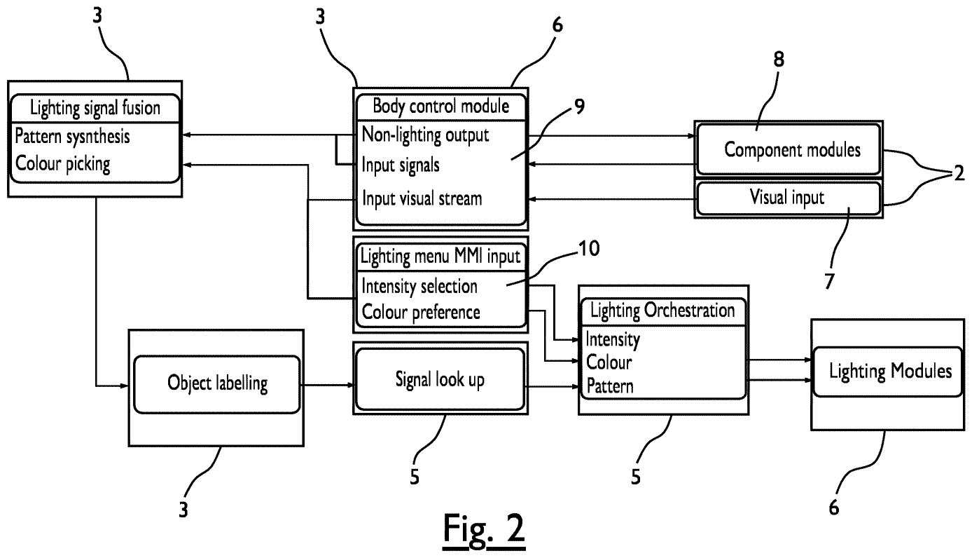

FIG. 2 is a flowchart of an ambient output system;

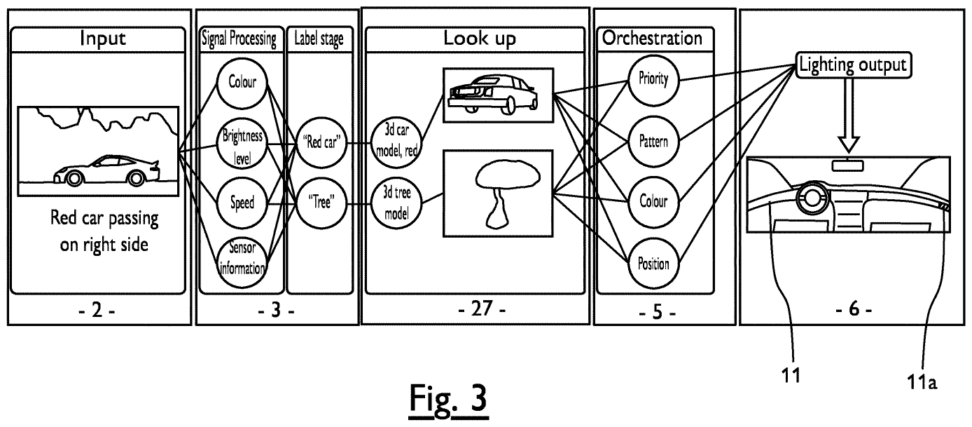

FIG. 3 is a block diagram of a first example of the operation of the ambient output system;

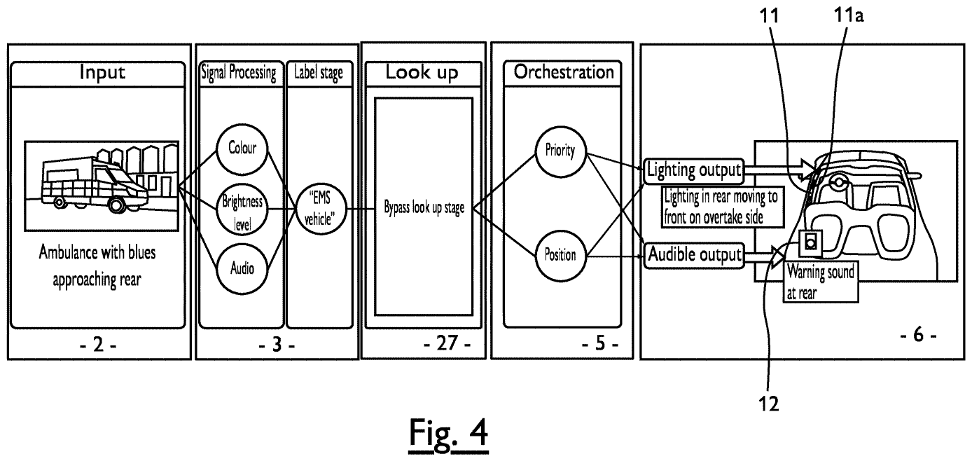

FIG. 4 is a block diagram of a second example of the operation of the ambient output system;

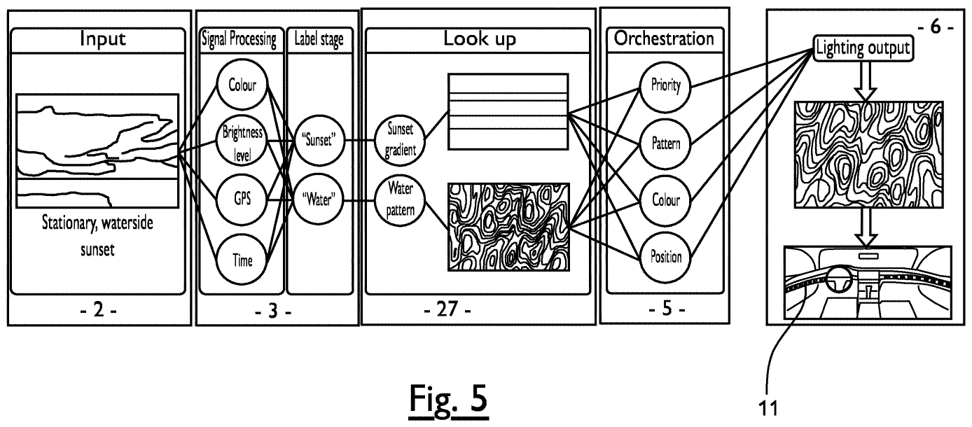

FIG. 5 is a block diagram of a third example of the operation of the ambient output system;

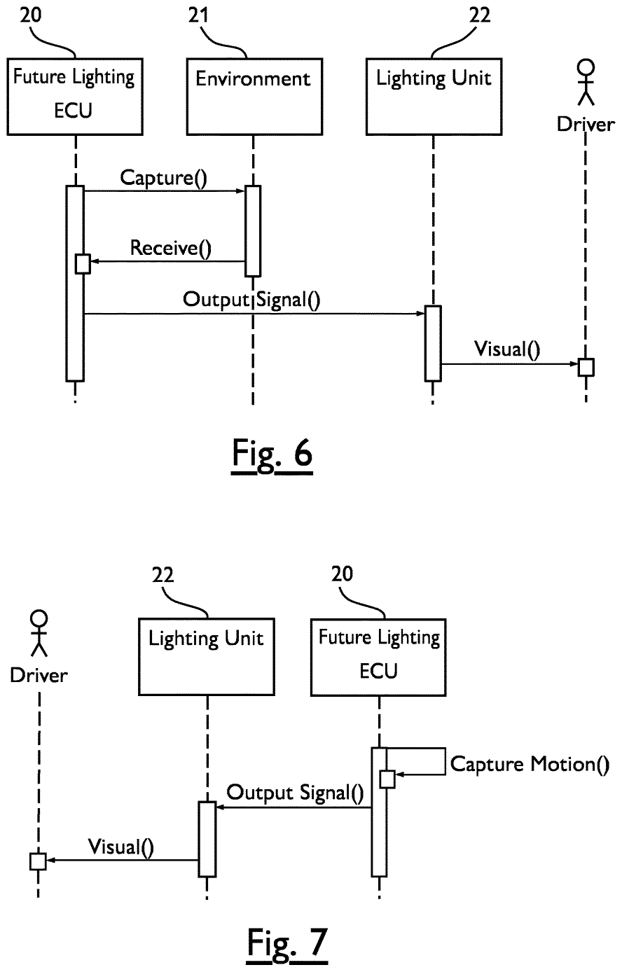

FIG. 6 is a validation view of a fourth example of the operation of the ambient output system;

FIG. 7 is a validation view of a fifth example of the operation of the ambient output system;

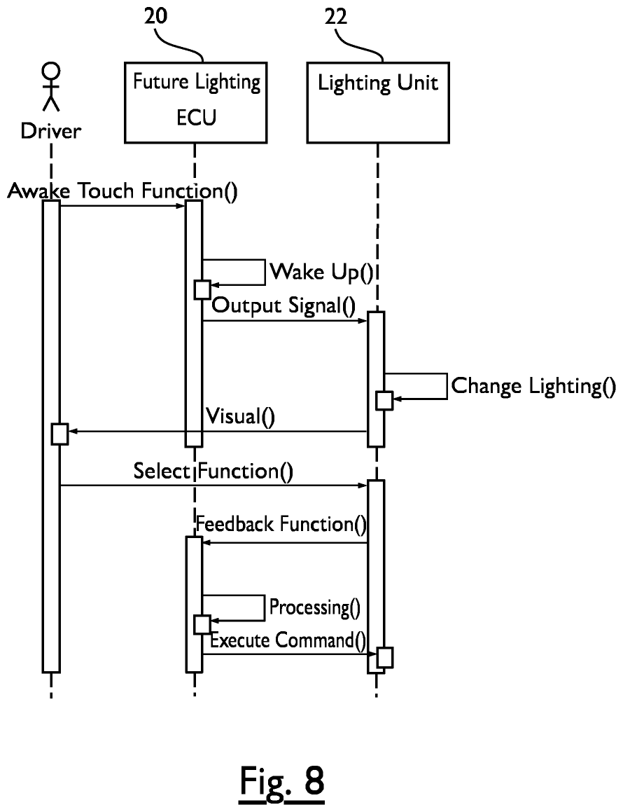

FIG. 8 is a validation view of a sixth example of the operation of the ambient output system;

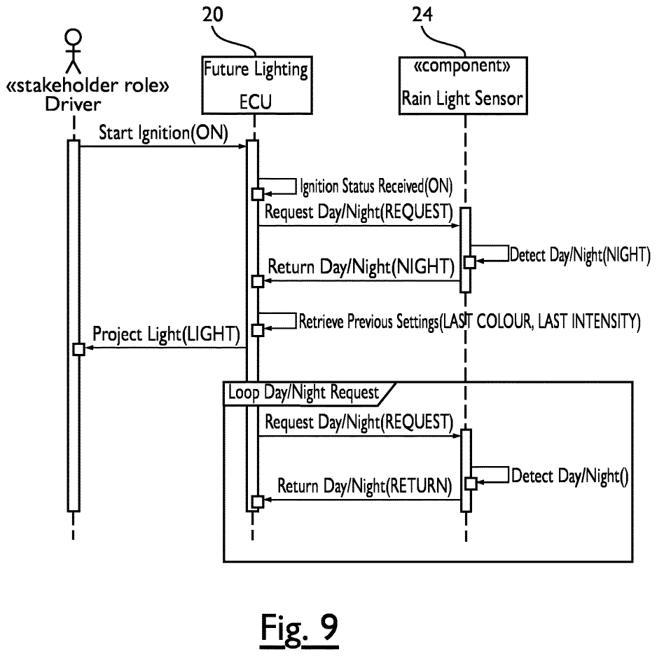

FIG. 9 is a validation view of a seventh example of the operation of the ambient output system;

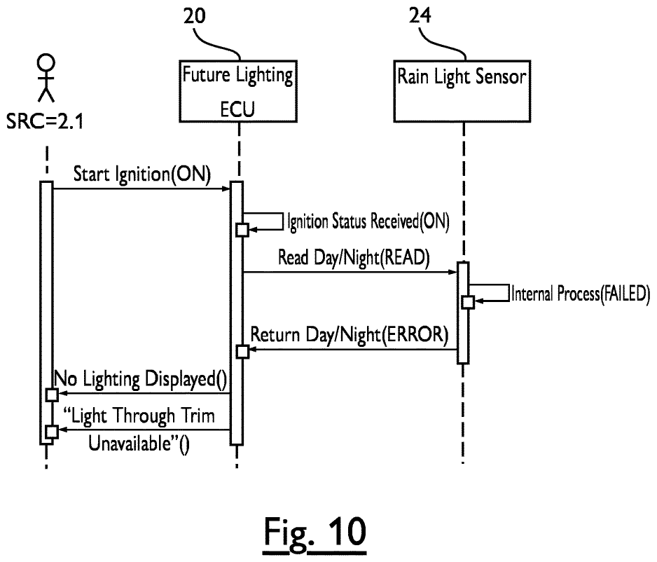

FIG. 10 is a validation view of an eighth example of the operation of the ambient output system;

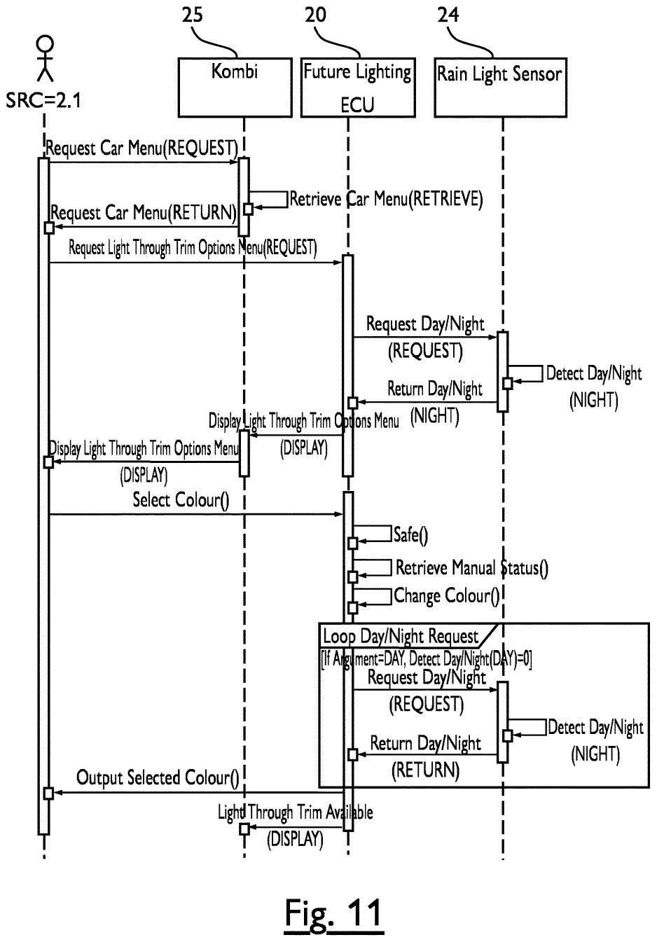

FIG. 11 is a validation view of a ninth example of the operation of the ambient output system;

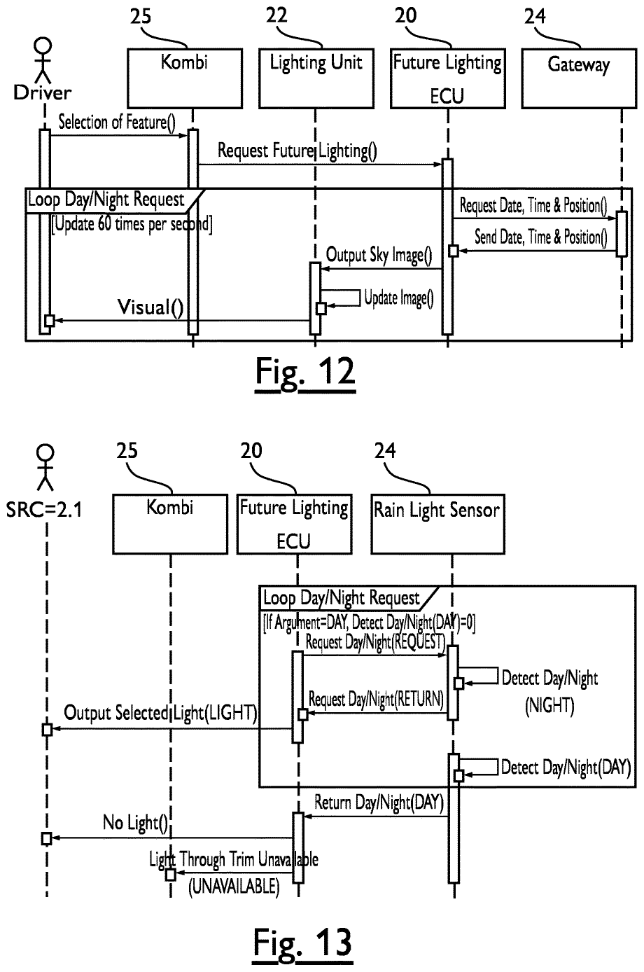

FIG. 12 is a validation view of a tenth example of the operation of the ambient output system;

FIG. 13 is a validation view of an eleventh example of the operation of the ambient output system; and

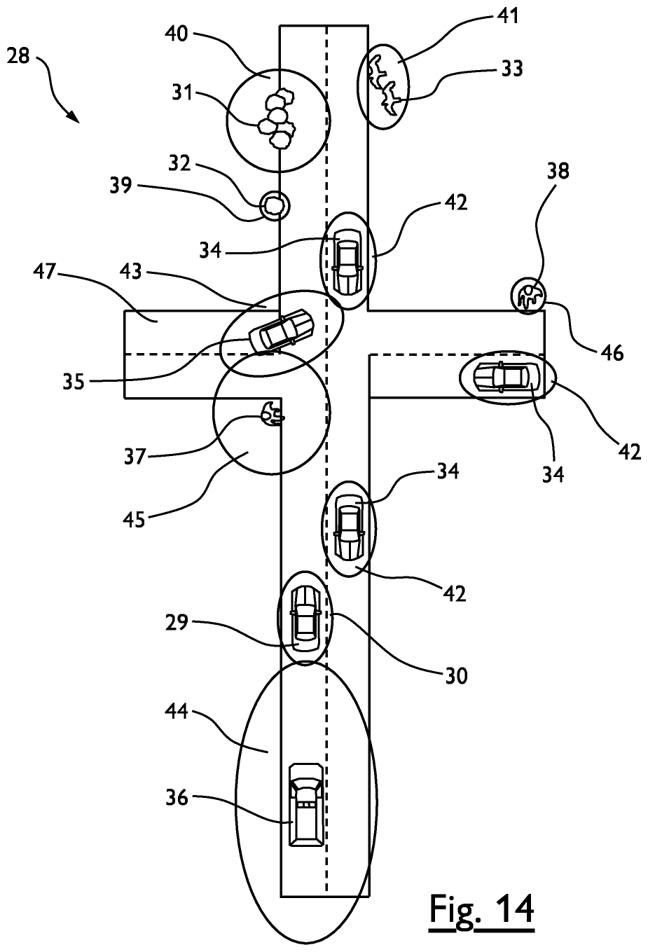

FIG. 14 is a virtual space of an ambient output system.

As shown in FIG. 1, an ambient output system 1 for a vehicle comprises a plurality of sensors 2, an identification unit 3, a memory unit 4, a rendering unit 26, an association unit 27, an orchestration unit 5, and ambient output devices 6.

The sensors 2 form part of the vehicle. One or more of the plurality of sensors 2 are arranged to monitor the environment external to the vehicle (e.g. positioned on the body of the vehicle and exposed to the external environment). These external sensors can obtain an input comprising an indication of one or more elements of the external environment. For example, a camera can obtain a visual input (either an image, series of images, or a video) which shows the weather, landscape, passing traffic, and/or other objects and/or elements in the external environment. Another example in one or more embodiments is a microphone, which can obtain an audio input including a recording of the sound of weather, landscape, passing traffic, and/or other elements in the external environment. A further example in one or more embodiments is an anemometer, operable to obtain a measurement of the wind speed in the external environment. Another example in one or more embodiments is an olfactory sensor, operable to obtain a recording of the odour in the external environment and so the odour of one or more elements in the external environment. In one or more embodiments one or more of the external sensors is a temperature sensor, operable to obtain a measurement of the temperature of the external environment. Another example of an external sensor is a daylight sensor. Another example of an external sensor is a rain sensor.

One or more of the plurality of the sensors 2 form part of the computing of the vehicle, and are operable to detect statuses related to the vehicle and/or measurements from the vehicle computing. Examples of which the or each in-built sensor can detect include the following: GPS location of the vehicle, altitude, and connection status of the vehicle to external devices such as smart home devices or mobile telephones, vehicle charging status, vehicle HVAC status, vehicle ‘mode’ active (for example, sports mode), specific doors being open/closed, wake up of the vehicle, ignition of the vehicle, time, speed, acceleration, and/or angle of the steering wheel.

Various embodiments can include any combination and number of the external and/or in-built sensors discussed, and other types of external and/or in-built sensors. Some embodiments can even have only one sensor 2.

In the embodiment of FIG. 1, the plurality of sensors 2 detects an indication of an element of the environment. The identification unit 3 receives these indications.

The identification unit 3, memory unit 4 and orchestration unit 5 form part of the computing of the vehicle. The identification unit 3 processes the indications received during a ‘signal processing’ step, determining the parameter or parameters making up the indication. For example, for the input from a temperature, daylight, or GPS sensor the respective parameters would be detected temperature, detected daylight, and GPS location. Other inputs would comprise a plurality of parameters. For example, a visual input comprises parameters including brightness, reflectivity, colour, and/or pattern. Further to this, visual input parameters can be related to specific positions and times within the image, series of images and/or video.

The identification unit 3 then proceeds to a ‘label stage’, in which it identifies elements based on one or more parameters. The identification unit 3 compares the parameters to a list of parameters and parameter ranges (each combination of one or more parameters or parameter ranges associated with an identity) stored within the memory unit 4. When specific values match the listed parameters or fall within the listed parameter range, or are close enough, and there are a specific minimum number of matching parameters to those listed for an identity, the identification unit 3 labels the feature associated with the detected parameters with the identity. The parameters labelled can be from one sensor 2, part of the input of one sensor 2 (for example, the brightness, colour, and/or other parameters of a section of an image) or can be from a plurality of sensors 2. As an example of the latter, the temperature, extent of sunlight, wind speed and/or audio or visual parameters of a particular type of precipitation can together be identified as a particular form of weather. As a further example, the daylight value and time can together be identified as particular time of day (e.g. twilight, sunrise, sunset, noon, dusk, dawn).

The labelled elements are then passed to the rendering unit 26. The rendering unit 26 creates and maintains a virtual space 28 (shown in FIG. 14), populated by the vehicle 29 and the identified elements. The virtual space 28 reflects the external environment, in that elements populating it are positioned within the space relative to the vehicle as they are in the external environment. The rendering unit 26 continuously updates the virtual space 28 as the vehicle 29 (and/or elements) move through the external environment.

In the virtual space 28 the vehicle 29 comprises an associated emanating field 30, emanating out from the central location of the vehicle 29 to form an oval. In the virtual space 28 of FIG. 14, the virtual space 28 is populated by identified elements as follows: Trees 31, 32, birds 33, other ordinary vehicles 34, 35, emergency services vehicle (also known as an EMS vehicle) 36, and pedestrians 37, 38. Within the virtual space 28 is rendered other elements as well. In the example of FIG. 14, the roads 47 are rendered.

The association unit 27 then receives the labelled elements to determine a set of conditions for the operation of the ambient output devices 6. To determine the set of conditions the association unit 27 carries out a “look up” step, reviewing a list of set of condition, associated identities, and associated priority ratings in the memory unit 4. The association unit 27 retrieves the set of conditions of the associated identities matching the labelled identities. The set of conditions dictate the operation of ambient output devices or a selection of the units of the ambient output devices. For example, when the ambient output is lighting and each unit is a lighting unit, the conditions include the brightness, frequency of any flashing, status on or off, colour, and/or colour change or colour cycling for each lighting unit of the strip or the selection, and/or the pattern formed by the entire strip or selection. Each condition of a set of conditions dictates a different operation of the ambient output devices, such that a plurality of conditions can be in effect on the same ambient output device or same part of an ambient output device. For example, one condition can dictate the brightness of a lighting unit while a further condition can dictate whether the same lighting unit flashes.

In some embodiments the receiving labels can apply a main label and one or more descriptive labels to an element. The main label gives the name of the element, while the one or more descriptive labels give further detail on the element. For example, the main label could be “rain”, while the descriptive label could be “heavy”. In another example, the main label could be “car”, while a descriptive label could be “black”. In the memory unit 4, some of the sets of conditions can each have an associated main or descriptive label (rather than an associated whole identity comprising a main label and one or more descriptive labels). As such, when the association unit looks up an identity it can result in obtaining a plurality of sets of conditions, the set associated with the main label and the sets associated with the descriptive label.

For example in the embodiment of FIG. 14, several of the identified elements can be labelled as follows: group of trees 31 and singular tree 32 (“tree” being the main label, “group” and “singular” being descriptive labels), ordinary vehicles not in the driver's vehicle's lane 34 and ordinary vehicles in the driver's vehicle's lane 35 (“ordinary vehicle” being the main label and “not in lane” and “in lane” being the descriptive labels), and pedestrian beside driver's vehicle's lane 37 and pedestrian not beside driver's vehicle's lane 38 (“pedestrian” being the main label and “beside lane” and “not beside lane” being the descriptive labels).

Each listed set of conditions can have an associated priority rating. Alternatively, in some embodiments, one or more of the sets of conditions can have different priority ratings for different conditions of the set.

The association unit 27 conducts the look up step for all the identified elements, and so ends up with a plurality of sets of conditions for the operation of the ambient output devices 6. It then associates the set of conditions with each identified element within the virtual space, applying emanating fields to each identified element which the set of conditions and priority rating (or priority ratings) is associated with.

The association unit 27 also looks up the identity and obtains an associated range for the emanating field, the memory unit 4 storing a range associated with each identity. The range of the respective emanating field is thereby set. Each emanating field is an oval or circular around the associated element.

So, in the example of FIG. 14, the trees' emanating fields 39, 40, the birds' emanating fields 41, the other ordinary vehicles' emanating fields 42, 43, the emergency services vehicle's emanating field 44, and the pedestrians' emanating fields 45, 46 are set in the virtual space.

Each main label and one or more of the descriptive labels can have an associated range and shape of emanating field. The range and/or shape of descriptive labels is chosen by the association unit 27 over the range of the main label. When choosing between ranges and/or shapes of descriptive labels, the range and/or shape of the descriptive label with the highest associated priority rating is chosen.

In the example of FIG. 14, “singular”, “not in lane”, and “not beside lane” do not have associated ranges. Accordingly, the singular tree emanating field 39, emanating field of the other ordinary vehicles not in the driver's vehicle's lane 42, and the emanating field of the pedestrian not beside the driver's vehicle's lane 46 have the range associated with the respective main label. “group”, “in lane”, and “beside lane” do have associated, larger ranges. Accordingly, the group of trees emanating field 40, the emanating field of the other ordinary vehicles in the driver's vehicle's lane 43, and the emanating field of the pedestrian beside the driver's vehicle's lane 45 have the larger range associated with the respective descriptive label.

The more relevant the identify of the element is to a user of the vehicle, the large the associated range such that the user is alerted to the element sooner as it comes near to it.

For “tree” and “pedestrian”, the shape of the emanating fields 39, 40, 45, 46 is a circle. For faster moving elements: “birds”, “ordinary vehicle”, and “emergency service vehicle”, the shape of the emanating fields 41, 42, 43, 44 is an oval. The oval emanating fields have a major axis oriented with the respective element's heading. In this embodiment, the minor axis of each oval is about half the size of the major axis. This helps the system to account for the heading of the element.

In this embodiment, the vehicle 29 also comprises an associated vehicle emanating field 30. This is an oval shape with a major axis aligned with the heading of the vehicle. The system can thereby better account for the heading/direction of travel for the vehicle.

The orchestration unit 5 then carries out an “orchestration” step. In this step the orchestration unit 5 first determines whether the vehicle emanating field 30 is overlapping with any emanating fields of identified elements in the virtual space 28.

In the embodiment of FIG. 14, the orchestration unit 5 determines the vehicle emanating field 30 is overlapping with the emergency service vehicle's emanating field 44.

The orchestration unit 5 also determines the position of some of the elements relative to the vehicle within the virtual space. The elements it does this for are those which have a condition indicating as such. The position dictates which ambient output devices 6 the rest of the set of conditions could apply to (and so sets this particular condition), with the ambient output devices chosen being those whose position relative to the centre of the vehicle mirror the position of the element relative to the vehicle.

In the example of FIG. 14, the orchestration unit 5 determines the emergency services vehicle 36 is directly behind the vehicle 29.

For these emanating fields, the orchestration unit 5 compares the associated sets of conditions with each other. When there are conflicting conditions (i.e. it is not possible for both or more conditions to be put into effect on the same unit or units of the ambient output) the priority rating associated with each conflicting condition (associated with it either directly or via associated with the overarching set) are compared. The conflicting condition with the highest priority rating is chosen to be put into effect, while the other conflicting condition or conditions are discarded. When one or more conditions do not conflict (i.e. it is possible to put them both or all into effect on the same unit or units of the ambient output) the orchestration unit choses for them to be put into effect. All the chosen conditions are combined to form a combined set of conditions for the ambient output devices 6.

The orchestration unit 5 then activates or changes the ambient output devices 6 based on the combined set of conditions. The ambient output devices 6 comprises a plurality of types of outputs, each type of output comprising a plurality of units. The types of outputs and units which comprise them include the following: ambient lighting devices such as an LED strip comprising LEDs, a dashboard lighting comprising LEDs and an LED ceiling panel comprising LEDs; an audio system comprising stereo units, a video screen comprising pixels; an olfactory system comprising olfactory actuators. The ambient output devices 6 thereby conveys a signal of a plurality of identified features at the same time.

In other embodiments the ambient output devices 6 can comprise only one type of output, or any combination of the various types of outputs, and/or each type of output can have only one unit or a plurality of units.

In the example of FIG. 14, the set of conditions associated with the emanating field 44 of the emergency vehicle 36 are used to set the ambient outputs of the vehicle 29.

The identification unit 3 is an artificial intelligence labelling system, which can be trained to determine the identities, labels and associated parameter and parameter ranges.

In the embodiment shown in FIG. 2, the sensors 2 are an external sensor 7 which is a camera (providing a visual input) and a plurality of in-built sensors 8 providing inputs from component modules of the vehicle. Indications from these sensors 7, 8 are passed to the body control module 9 of the vehicle, which forms part of the identification unit 3.

As shown in the embodiment of FIG. 2, and as is the case for the embodiment of FIG. 1, the user can select a default set of conditions for the ambient output devices 6. In the embodiment of FIG. 2, this is selection is carried out by a lighting menu MMI input 10, which forms part of a selection unit comprising a touch screen on the dashboard of the vehicle. The user can select the intensity (e.g. when the ambient output is lighting, the brightness) and colour deference to result in a default set of conditions. These default set of conditions can be changed at will, whenever the user accesses the selection unit. The default set of conditions have an associated priority rating, the rating set when the system is first created.

The user can also select a number of different default set of conditions, the particular default set of condition to be used chosen by the orchestration unit 5 depending on an identified indication. For example, the default set of conditions to be used can depend on whether it is “day” or “night” (the label being applied to a time and/or amount of light parameter).

The default set of conditions and associated priority rating are taken together with the inputs from the sensors 7, 8, and the body control module 9 carries out labelling on indications of the inputs. The body control module 9 also forms part of the association unit 27 and orchestration unit 5, and so also performs look up and then orchestration. During orchestration the default set of conditions are another set of conditions compared to the rest and for which priority rating comparisons are made if there is a conflict. The combined set of conditions are then passed to the lighting modules of the vehicle, which form part of the ambient output devices 6 by controlling the ambient light outputs, and which then implement the combined set of conditions.

The body control module 9 also forms part of the ambient output devices 6, implementing the combined set of conditions insofar as they relate to non-lighting outputs. These conditions are implements on the component modules 8 of the vehicle.

An example of the functioning of the ambient output system 1 for a particular input is shown in FIG. 3. In this example the sensors 2 include an external sensor which is a camera, capturing a series of images of the external environment to one side of the vehicle. The images captured show a red car on a road, with a background of trees. This input is provided to the identification unit 3. The identification unit 3 carries out object localisation to note the presence of the red car and the trees within the image. The identification unit 3 then carried out object recognition on each object localised, using the parameters of the pixels making up each object (e.g. colour, brightness, pattern of pixels forming shapes, speed of the object based on movement of the position of the object between consecutive images, reflectivity) to identify each object and label it. This object recognition can be in conjunction with parameters from other sensors 2, for example microphone recording audio of the red car passing. For the car a main label of “car” is applied, along with a descriptive label of “red” (although in other embodiments it may just be one label of “red car”). For the trees only a label of “tree” is applied.

The association unit 27 then looks up the set of conditions (and associated priority ratings) for a “red car” and “trees”. In this embodiment an LED strip 11 forms part of the ambient output devices 6, the strip extending across the dashboard of the vehicle and along the side doors of the vehicle. For a “car” the condition is a pattern of activated LEDS ‘moving’ along an LED strip on a particular side of the vehicle, the side and speed of movement determined by the parameters of the position and speed of the red car in relation to the vehicle as noted by the sensors 2. For example, if the car is to the right of the vehicle, the LEDS are activated along the right-hand side door LED strip of the vehicle. To continue the example, the speed of the vehicle and speed of the ‘movement’ of the activated LEDs is matched so the position of the activated LEDs towards the front or back of the vehicle corresponds to the position of the red car in relation to the front or back of the vehicle (i.e. if the red car is overtaking the vehicle the ‘movement’ is from the back of the vehicle to the front and its speed matches the speed of the overtaking red car). For “red” the condition dictates that the activated LEDs be red. For “trees” the conditions dictate that LEDs in the respective positions be activated and brown. In the present example, given the image shows trees across the entire background and other cameras facing other directions from the vehicle show trees all around the vehicle, this parameter of position of trees is taken and results in the activated LEDs for the set of conditions of “trees” being all the LEDs of the strip.

The orchestration unit 5 then compares the set of conditions for “red car” and “tree”, and determines the position of the “red car” relative the vehicle. The conditions of activated LEDs moving are red and those same LEDs are brown conflict, and as such the orchestration unit 5 compares the priority ratings associated with each. The priority rating of the redness of the “red” is higher than the priority rating of the “brown” of the trees, and so the condition for red overrules the condition for brown. The set of conditions for the “red car” has no requirements for the activation or otherwise of the other LEDs, and so the brown condition for these LEDs is still implemented. Further, both sets of conditions want the ‘moving’ activated LEDs to be activated, and the set of conditions for “tree” do not dictate a particular pattern, and so the relevant conditions of both sets in relation to this are implemented.

The resulting combined set of conditions is implemented on the LED strip 11 of the ambient output devices 6, resulting in most of the LED strip being brown except for a pattern of ‘moving’ red LEDs 11a (in the present example, moving from the back of the vehicle to the front along the LED strip on the right-hand side doors of the vehicle). Accordingly, the ambient output devices 6 conveys an indication of both the red car and the trees at the same time, allowing the ambient output devices 6 to convey an overall ambient lighting matching the general environment (i.e. the trees) as well as the convey the useful information of the red car overtaking.

FIG. 4 shows another example of the function of the ambient light system 1. The sensors 2 comprise a camera capturing images of the external environment to a particular side of the vehicle, and a microphone capturing audio of the external environment, while the ambient output devices 6 comprise an LED strip 11 and a sound system 12. The captured images show an EMS vehicle, namely an ambulance, overtaking the vehicle, and the audio records the noise of the ambulance. The identification unit 3 receives the series of images and captured audio, along with a default set of conditions setting a default colour and brightness for the whole LED strip and default audio and volume for the speakers (e.g. radio or music). Object localisation and object recognition is carried out on the series of images. For the captured audio, the identification unit 3 carries out audio signal separation on the captured audio to separate out the audio of the ambulance from the rest of the recording (and any audio relating to other objects and/or elements). The identification unit 3 then carried out audio signal identification (alongside the object recognition) to identify the parameters making up the separated audio as “EMS vehicle”. The “EMS vehicle” labelled parameters from the images and audio are combined and passed to the rendering unit 26 and the association unit 27.

The association unit 27 notes the label “EMS vehicle”, and on this basis skips the look up step for sets of conditions to avoid a delay in conveying an indication of the EMS vehicle to the driver. Instead, the set of conditions is based wholly on the parameters of the indications of the “EMS vehicle”, and not on a combination of the parameters and looked up sets of conditions like the example of FIG. 3. The colour, brightness and frequency of flashing parameters of the EMS vehicle dictate the colour, brightness and frequency of flashing of the activated LEDs of the LED strip 11. The position of the EMS vehicle relative to the vehicle will dictate which LEDs about the LED strip 11 to activate. The audio sample of the EMS vehicle dictate the audio recording outputted by activated speakers of the sound system 12 of the ambient output devices 6. Finally, the position of the EMS vehicle relative to the vehicle dictate which speakers to activate, e.g. the speakers/ambient output devices may comprise left, right, front or back speakers/output devices spaced around the vehicle. This allows the ambient output devices to provide a more immersive experience.

The association unit 27 sets the priority rating of the “EMS vehicle”. The rating is set high, given the skipped look up step.

The resulting set of conditions are compared to the default set of conditions by the orchestration unit 5, and the position of the EMS vehicle relative the vehicle is determined given the condition dictating that the ambient output devices to be activated be based on this position. Given the priority ratings of the EMS vehicle set of conditions are higher than the priority ratings of the default set of conditions, the conflicting conditions of the EMS vehicle set of conditions overwrite the respective conflicting conditions of the default set. Given in the example shown the EMS vehicle is overtaking on the left of the vehicle, the resulting output of the ambient output devices 6 is as follows: a flashing set of LEDs 11a the colour, brightness and frequency of the EMS vehicle's flashing lights, along the left-hand side of the vehicle and ‘moving’ along the LED strip 11 from the back of vehicle to the front at the same speed as the EMS vehicle, while the rest of the LED strip is the chosen colour and brightness, and the sound of the EMS vehicle moving from speaker to speaker along the left-hand side of the vehicle from back to front at the same speed as the EMS vehicle and the rest of the speakers outputting the set radio or music (at the set volume).

FIG. 5 shows a further example of the operation of the ambient light system 1. In this example, the captured images from a camera of the sensors 2 show a sunset above a body of water. The “water” and “sunset” are identified and labelled by the identification unit 3 as separate features based on the parameters from the camera input and the time from a clock sensor and the GPS location from a GPS locator.

The labelled features and parameters are passed to the association unit 27, which carries out a look up for each feature. For the “sunset” the set of conditions dictate all the LEDs of the LED strip 11 being activated, transitioning in colour from blue on the right-hand side to orange on the left-hand side. For the “water” the set of conditions dictate green activated LEDs in a repeating pattern of on and off LEDs. Each feature has a different priority rating for conditions in the respective set. For the “sunset”, the colour has a high rating and the pattern of all LEDs being on has a low rating. For the “water” the colour has a low rating and the pattern of repeating on and off LEDs has a high rating. As such, the resulting combined set of conditions placed on the LED strip 11 of the ambient output devices 6 is a gradient of blue to orange LEDs from right to left in a repeating on and off pattern. As such, the LEDs convey both the sunset and the water of the surroundings to a vehicle user.

In the above discussed embodiments or other embodiments, the ambient output system 1 can comprise any or all of the following sensors in addition or alternatively to those mentioned previously, and the associated set of conditions of the features detected can have the ambient output the following:
a vehicle dynamic sensor operable to detect the traction control setting, ‘mode’ of the vehicle (e.g. ‘sports’ mode, ‘charisma’ mode), and/or ride height, resulting in the ambient output indicating a one or more of these settings;
a steering angle sensor operable to detect the steering wheel angle, the ambient output thereby indicating the angle and/or taking action to compensate for motion sickness based on the angle;
a HVAC sensor operable to detect the setting of the HVAC, the ambient output thereby indicating the setting;
a light sensor operable to detect the amount of ambient light, the ambient output ‘compensating’ for any lack of light;
a rain sensor operable to detect the amount of rain on the vehicle, the ambient output indicating the presence and/or strength of precipitation;
a pressure sensor operable to detect the presence of a user within a seat, part or all of the ambient output activating if particular seats are occupied;
an internal environment temperature sensor, the ambient output indicating the measured temperature;
an external environment temperature sensor, the ambient output indicating the measured temperature;
a Radar sensor, to identify or assist in identifying objects in the external environment of the vehicle and the ambient output indicating said objects;
a LiDAR sensor, to identify or assist in identifying objects in the external environment of the vehicle and the ambient output indicating said objects;
an accelerometer operable to determine the acceleration of the vehicle, the ambient output indicating this and/or compensating for motion sickness based on acceleration;
a charging status sensor operable to determine the amount by which the battery is charged and whether charging is taking place, and the ambient output indicating the charge/charging status;
a connection sensor operable to determine whether the vehicle is connected to smart home devices and the ambient output indicating the presence of this connection;
internal microphones operable to capture audio of the internal environment of the vehicle, and the ambient output conveying an indication of the detected audio of objects and/or elements;
an ignition sensor and/or car wake up sensor operable to determine if the vehicle ignition has started and/or whether the vehicle computing has awoken;
one or more car door position sensors each operable to detect if a specific door is open, the ambient output indicating if the specific door is open;
a GPS sensor operable to detect the location, orientation, altitude, time and/or other map data, the information being used to assist in identifying (or identify) features.

Types of ambient outputs and the indications they convey for these and/or other embodiments can include the following:
internal environment lighting (e.g. LED strips, dashboard lighting) changing colour based on the time of day or ambient lighting, for example providing mood lighting based on time of day;
a screen, providing dynamic music visuals based on song and/or genre; lighting to illuminate a blind spot when a detection of traffic in the blind spot is made;
a warning of an imminent crash when traffic is detected in a dangerous position;
an indication of when to turn and distance to turn via ambient lighting;
an LED ceiling panel, and an indication of the position of stars relative to the vehicle via the panel;
A waterfall light, indicating the weather; and/or
An indication of the light signals (e.g. turning signals) of surrounding traffic.

For embodiments in which elements internal to the vehicle are conveyed, for these elements the rendering unit 26 is skipped, and the creation and association with an emanating field by the association unit 27 is also skipped. Instead, the association unit looks up the set of conditions for these elements and they are then passed to the orchestration unit 5 for comparison with any other internal elements or external elements in which the vehicle is within the emanating field of.

In these embodiments, one or more of the plurality of sensors 2 are arranged to monitor the internal environment of the vehicle (e.g. positioned exposed to the internal environment, on the inner body of the vehicle). One or more of the internal sensors are a camera, microphone, olfactory sensor, and/or temperature sensor. A further example of an internal sensor is a pressure sensor, operable to detect the weight in a specific seat of the vehicle.

For embodiments with a variety of different types of sensors 2, the orchestration unit 5 is operable to limit the total number of indications conveyed at once, to avoid overwhelming the driver. The orchestration unit 5 conveys indications for the features with the highest priority rating, and discards the rest.

As an alternative or additional way to reduce the number of indications provided at once, the user can use the selection unit to determine which sensors to use and which indications to provide and/or prioritise if and when said indications are captured.

In relevant embodiments, the identification unit 3 can label parameters (such as time, distance to traffic/next turn on a navigation route, amount of precipitation, etc.) with a label relating to a parameter range in which the parameter falls. For example, time can result in a label of dusk, dawn, twilight, noon, etc. Distance can result in close (e.g. overtaking, risk of crash, turn imminent), medium, far (e.g. irrelevant, turn not for some time). Amount of precipitation can result in light, medium, heavy (e.g. dangerous).

In the embodiment shown in FIG. 6, the sensors 2, identification unit 3 and orchestration unit 5, and memory unit 4 are formed by a future lighting engine control unit 20 (ECU). The future lighting ECU 20 captures and receives one or more indications of features in the environment 21 (external and/or internal). The resulting combined set of conditions is provided to the lighting 22 (an LED strip, LED ceiling lighting panel, dashboard lighting, waterfall light, blind spot illumination and/or other lighting), which then provides a visual to the driver 23 conveying an indication of the or each feature.

In the example shown in FIG. 7 the future lighting ECU 20 detects an indication which is labelled as “motion”. The indication is formed from a steering angle beyond a set angle in either the clockwise or anti-clockwise direction, acceleration beyond a set acceleration and/or speed below a set speed, each parameter obtained by a steering angle sensor, accelerometer and speedometer respectively. The set of conditions for “motion” set the lighting 22 to reduce motion sickness.

In the example shown in FIG. 8 the driver is waking the vehicle computing. They select a wake up function via an input (e.g. a button) of the selection unit. The future lighting ECU 20 receives the indication from the input and identifies it as “wake-up”. It then instructs the lighting 22 to output light to the driver, indicating the computing has awoken.

Once the “wake-up” indication has been conveyed to a driver, they can utilise the selection unit to select a choice of lighting and brightness. This default set of conditions is sent directly to the lighting 22, which feeds back to the future lighting ECU 20. The default set of conditions is combined by the future lighting ECU 20 with any set of conditions of any identified features detected by the sensors. The combined set of conditions is then provided to the lighting 22.

The memory unit 4 can store the one or more default set of conditions chosen by the user previously. In the example of operation shown in FIG. 9, driver turns the ignition key to the vehicle. An ignition sensor monitors the ignition circuit and captures an indication of ignition. Of course, in other embodiments ignition could be equivalently triggered by a keyless start system such as a start/stop button or similar.

This indication is provided to the future lighting ECU 20, which identifies it as “ignition”. The future lighting ECU 20 checks sensors monitoring indications of the time of day 24 (clock sensor forming part of the vehicle components, a waterfall light sensor) and receives indications from these sensors. These indications are labelled together as “night” given the specific parameters returned, and the future lighting ECU 20 retrieves the default set of conditions associated with “night”. This set of conditions is used for the combined set of conditions for light to the driver. The future light ECU 20 then rechecks the sensors monitoring indications of the time of day 24 on a loop, at set times. As such, when the label changes to “day” the set of conditions can change as well.

In the example of FIG. 10 the driver turns the ignition key (or otherwise starts/activates the vehicle), and the future lighting ECU 20 identifies “ignition” and attempts to retrieve information on whether it is day or night. However, the sensors 24 fail, and return an error indication to the future lighting ECU 20, which identifies the indication as an error. The future lighting ECU 20 then returns a “lighting unavailable” to the dashboard touchscreen to be displayed, so the driver knows the ambient output system 1 is on but there is an issue.

In the example of FIG. 11 the selection unit and control for the ambient output devices 6 together form the dashboard control unit 25. The driver accesses the selection unit via the dashboard control unit 25, requesting the car settings menu which is retrieved and provided on the screen. The driver then requests the trim (i.e. the LED strips and dashboard lighting) settings menu, which is passed to the future lighting ECU 20. The future lighting ECU 20 identifies the request and retrieves the set of conditions associated with “day” or “night” (retrieved and identified as in the example of FIG. 9). The combined set of conditions is passed back to the dashboard control unit 25 which instructs a trim settings menu to be displayed to the driver. The set of conditions of “day” or “night” can adjust the options available on the menu eventually displayed, and whether the menu allows for the selection of “day” default sets of conditions or “night” default sets of conditions.

The driver then selects a light colour and brightness for the trim, which is provided to the future lighting ECU 20. The future lighting ECU 20 uses these settings going forwards as the default set of conditions for “day” or “night” (depending on the previously identified time). The combined set of conditions is provided to the dashboard control unit 25, which then instructs the ambient output devices 6 to output the required light to the driver. The future lighting ECU 20 then conducts the loop discussed in FIG. 9. The future lighting ECU 20 also instructs the dashboard control unit 25 to output “light through trim available”, as part of the combined set of conditions.

In the example of FIG. 12, the driver selects activation of the LED ceiling panel as a night sky panel through the selection unit via the dashboard control unit 25. The request is passed to the future lighting ECU 20, which obtains time, date and vehicle location parameters from the relevant sensors 2. These parameters are identified as “night sky” and are used to look up the current night sky above the vehicle. The set of conditions obtained from the look up, to replicate the current night sky on the LED ceiling panel, are passed to the lighting 22. The future lighting ECU 20 then loops, rechecking the time, date and position parameters 60 times per second and updating the visual when necessary.

In the example of FIG. 13 the ambient output system operates in the same manner as the example of FIG. 9 or FIG. 11. During the loop though, the parameters indicate a change from “night” to “day”. The associated set of conditions require the lighting 22 to deactivate and the dashboard screen to indicate the light through trim is unavailable, rather than just changing the lighting 22 output (in colour or brightness).

While the embodiments of FIGS. 6-13 discuss ambient output systems 1 wherein the ambient output devices 6 is lighting, in other embodiments the ambient output devices 6 can comprise other types of output and/or lighting and still function in the same manner (merely with sets of conditions including conditions for the other types of output).

The one or more embodiments are described above by way of example only. Many variations are possible without departing from the scope of protection afforded by the appended claims.

1. An ambient output system for a vehicle comprising:
a. a detector operable to detect a plurality of elements of an environment external to the vehicle;
b. an identification unit operable to identify each element;
c. a rendering unit operable to create a virtual space representing the environment external to the vehicle, the rendering unit operable to populate the virtual space with the vehicle and each identified element;
d. an association unit operable to apply a respective emanating field to each identified element within the virtual space, the respective emanating field being based on the identity, and each emanating field emanating from the identified element, and within the virtual space, to an associated range;
e. one or more ambient output devices operable to set the internal ambient environment of the vehicle; and
f. an orchestration unit operable to determine any emanating fields the vehicle is within in the virtual space and set the output of the one or more ambient output devices at least partially based on any emanating field or emanating fields the vehicle is within.

2. An ambient output system according to claim 1 wherein the emanating field associated with at least one of the identified elements is a non-circular emanating field.

3. An ambient output system according to claim 2 wherein the non-circular emanating field comprises a major axis aligned with a heading of the respective identified element.

4. An ambient output system according to claim 3 or claim 4 wherein the non-circular emanating field is an oval or is the same shape as an outer edge of the respective identified element.

5. An ambient output system according to any preceding claim wherein the vehicle comprises a vehicle emanating field in the virtual space, and the orchestration unit is operable to determine any emanating fields the vehicle is within by determining any emanating fields of identified elements which overlap with the vehicle emanating field.

6. An ambient output system according to claim 5 wherein the vehicle emanating field comprises a major axis aligned with a heading of the vehicle.

7. An ambient output system according to any preceding claim wherein the one or more ambient output devices comprise ambient lighting devices and/or speakers.

8. An ambient output system according to any preceding claim wherein the orchestration unit is operable to use a set of conditions associated with an emanating field in which the vehicle is within to set the output of the one or more ambient output devices.

9. An ambient output system according to any preceding claim wherein the orchestration unit is operable to set the output of the one or more ambient output devices based on a combination of a plurality of sets of conditions, each set of conditions being associated with a respective emanating field which the vehicle is within.

10. An ambient output system according to claim 9 wherein the orchestration unit is operable to set the output of the one or more ambient output devices based on a combination of a plurality of sets of conditions, one set of conditions being a default set of conditions and the rest of the plurality of sets of conditions each being associated with a respective emanating field which the vehicle is within.

11. An ambient output system according to claim 10 further comprising a memory unit operable to store a list of priority ratings associated with each element, and wherein the association unit is operable to look-up in the memory unit the priority rating associated with each element and associate each priority rating with the respective emanating field, wherein the orchestration unit is operable to compare the conditions of the plurality of sets of conditions and:
a. when two or more conditions for a particular output setting of the one or more ambient output devices conflict, the orchestration unit is operable to select the conflicting one or more conditions with the highest priority rating to put into effect and disregard the conflicting one or more other conditions; and
b. when two or more conditions for a particular output setting of the one or more ambient output devices do not conflict, the orchestration unit is operable to put the non-conflicting two or more conditions into effect.

12. An ambient output system according to any one of claims 9 to 12 wherein the identification unit is operable to identify if an external element is an emergency services vehicle (EMS vehicle) and to label an element as an EMS vehicle, and the orchestration unit is operable to detect if one or more elements are labelled as EMS vehicle and, if one or more elements are labelled as EMS vehicle, set the output of the one or more ambient output devices based only on sets of conditions associated with elements labelled as EMS vehicle.

13. An ambient output system according to any preceding claim wherein the identification unit is operable to determine a time of day and the orchestration unit is operable to set the output of the one or more output devices at least partially based on the time of day.

14. An ambient output system according to any preceding claim wherein, for one or more elements corresponding to emanating fields the vehicle is within in the virtual space, the orchestration unit is operable to determine the position of the one or more elements relative to the vehicle and adjust a set of conditions corresponding to each of the one or more elements based on the position of each respective element relative to the vehicle.

15. An ambient output system according to any preceding claim comprising a memory unit operable to store a list of ranges of emanating fields associated with identities, and wherein the association unit is operable to look-up in the memory unit the range associated with the identity of each element and set the range of the emanating field for each element.

16. An ambient output system according to any preceding claim comprising a memory unit operable to store a list of shapes of emanating fields associated with identities, and wherein the association unit is operable to look-up in the memory unit the shape associated with the identity of each element and set the shape of the emanating field for each element.

17. A vehicle comprising the ambient output system of any of claims 1-16.

18. A vehicle according to claim 17 wherein the ambient output system comprises two or more ambient output devices provided spaced around the vehicle.

19. A method of providing an ambient environment for a vehicle, comprising:
a. detecting a plurality of elements of an environment external to the vehicle;
b. identifying each element;
c. rendering a virtual space representing the environment external to the vehicle and populating the virtual space with the vehicle and each identified element;
d. applying a respective emanating field to the or each identified element within the virtual space, the respective emanating field being based on the identity, and each emanating field extending from the identified element, and within the virtual space, to an associated range;
e. determining any emanating fields the vehicle is within in the virtual space and setting the output of one or more ambient output devices of the vehicle at least partially based on any emanating field or emanating fields the vehicle is within.
